(19) United States
(12) Patent Application Publication
(10) Pub. No.: US 2004/0122938 A1
(43) Pub. Date: Jun. 24, 2004

(54) Method and apparatus for dynamically allocating storage array bandwidth

(76) Inventors: Randall E. Messick, Boise, ID (US); E. Jeffrey Peone, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/325,166

(22) Filed: Dec. 19, 2002

(51) Int. Cl. G06F 15/173

(52) U.S. Cl. 709/224; 709/225

(57) ABSTRACT

A method for managing bandwidth allocation in a storage area network includes monitoring a response time of data storage resources to requests from applications on at least two client devices to produce response time data determining whether a trigger condition is met based on the response time data; and, if said trigger condition is met, adjusting bandwidth allocation levels of the applications. A system for implementing this method may include a management station configured to control bandwidth between one or more data storage devices and a plurality of applications that run on one or more client devices. The management station monitors response times in which the data storage device responds to requests from the applications and adjusts bandwidth allocations for the applications based on the response times.

### BACKGROUND

The use of computers and computer networks pervades virtually every business and other enterprise in the modern world. With computers, users generate vast quantities of data that can be stored for a variety of purposes. This body of data can grow at a phenomenal pace and become critically valuable to those who have generated it. Consequently, there is an ever-present need for data storage systems that improve on capacity, speed, reliability, etc.

Within a computer network, the computers of the network may draw upon additional data storage resources that are available through the network. For example, networked computers may store data on network servers or other data storage devices connected to the network, such as hard drives, floppy disk drives, tape drives, optical disc drives, magneto-optical disc drives, and other data storage devices. Frequently, multiple data storage disks are combined in a disk array. For large systems with relatively large data storage needs, one or more arrays of data storage disks may be added to the network.

Storage Area Networks (SANs) are an emerging technology being implemented to accommodate high-capacity data storage devices, particularly disk arrays, within a network. A SAN is essentially a high-speed network between client devices, such as servers and personal computers, and the data storage devices available to those clients, particularly disk arrays. A SAN overcomes the limitations and inflexibility of traditional attached data storage.

While a SAN can overcome the limitations of traditional attached data storage, it also introduces new considerations. In particular, SANs experience competition for resources when more than one client is attempting to access the same data storage device. A typical storage device has a limited amount of bandwidth in its Input/Output (I/O) paths. This limited amount of bandwidth must be portioned out to the clients accessing the storage device.

### SUMMARY

In one of many possible embodiments, the present invention provides a method for managing bandwidth allocation in a storage area network that includes monitoring a response time of data storage resources to requests from applications on at least two client devices to produce response time data, determining whether a trigger condition is met based on the response time data, and, if the trigger condition is met, adjusting bandwidth allocation levels of the applications.

In another possible embodiment, a system for implementing the invention may include a management station configured to control bandwidth between one or more data storage devices and a plurality of applications that run on one or more client devices. The management station monitors response times in which the data storage device responds to requests from the applications and adjusts bandwidth allocations for the applications based on the response times.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1 is a block diagram illustrating a storage area network according to one embodiment of the present invention.

FIG. 2 illustrates a bandwidth allocation process according to one embodiment of the present invention.

FIG. 3 is a flow chart illustrating an I/O bandwidth determination algorithm according to one embodiment of the present invention.

Throughout the drawings, identical reference numbers designate similar, but not necessarily identical, elements.

### DETAILED DESCRIPTION

A method for allocating storage array bandwidth described herein is based on response time monitoring. According to one exemplary implementation, described more fully below, a management station monitors the response time of networked data storage resources to the requests of a number of applications or tasks (hereinafter, collectively “applications”) running on a population of client devices, e.g., networked servers and computers. The management station then adjusts bandwidth allocations, when needed, based on the results of the response time monitoring.

In the following description, for purposes of explanation, numerous specific details are set forth in order to provide a thorough understanding of the invention. It will be apparent, however, to one skilled in the art that the invention can be practiced without these specific details. Reference in the specification to “one embodiment” or “an embodiment” means that a particular feature, structure, or characteristic described in connection with the embodiment is included in at least one embodiment of the invention. The appearance of the phrase “in one embodiment” in various places in the specification are not necessarily all referring to the same embodiment.

Exemplary Structure

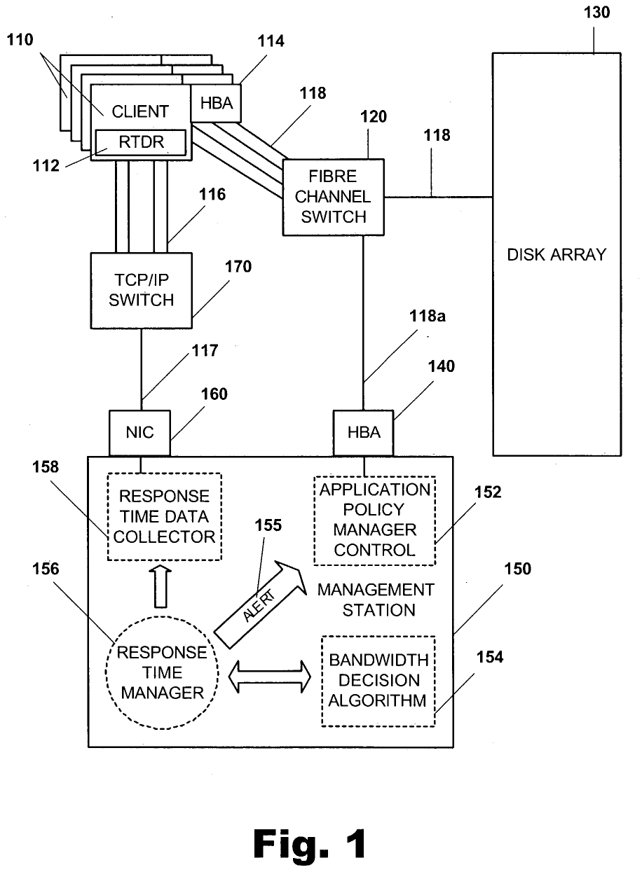

Storage area networks vary in size and complexity, and are flexible in their configurations for meeting the storage needs of the network served. A simplified storage area network configuration is depicted in FIG. 1 to illustrate the transfer and management of data between a limited number of client devices interfaced with the storage area network. More complex storage area networks may interface with any number of devices as needed to meet the collective storage needs of the client devices. The principles described herein may be applied to any SAN irrespective of size or complexity.

As is illustrated in FIG. 1, a storage area network includes one or more client devices (110), for example, host servers or personal computers. Typically, each client device (110) is capable of running applications that, when executed, may need to make use of data storage resources available through the network.

Each client device also contains a response time data reporter (112). The response time data reporter (112) may also be an application or task running on each client device (110) or may, alternatively, be a hardware unit, such as an application-specific integrated circuit or the like.

Each client device (110) is preferably connected to the storage area network through a host bus adapter (HBA) (114). Each HBA (114) is connected to a communication line (118) that couples the client device (110) to additional data storage resources, for example, the disk array (130).

The communication line (118) is preferably a fibre channel loop that is compliant with the “Fibre Channel Physical and Signaling Interface” ((FC-PH) Rev. 4.3, X3T11, Jun. 1, 1994 standard, American National Standards for Information Systems). Each device on the fibre channel loop (118), by virtue of the fiber channel host bus adapter (114), has a unique identifier, referred to as its worldwide name (WWN), which may be used to uniquely identify and distinguish that device on the fibre channel loop (118). Other alternative means of uniquely identifying each device among the interconnected devices may also be used.

Continuing in the direction of the communication line (118), the line (118) is fed into a fibre channel switch (120). The fibre channel switch (120) allows multiple applications running on one or more client devices (110) to retrieve information from, or send information to, the disk array (130) at the same time. Alternatively, any device capable of controlling bandwidth allocations for client devices to the disk array (130) can be used in place of the fibre channel switch (120). From the fibre channel switch (120), the communication line (118) continues on to a port of the disk array (130).

The disk array (130) is a data storage unit that is made up of a number of data storage disks or other data storage devices. The disk array (130) divides data into a number of logical volumes. These volumes can then be accessed through a logical unit number (LUN) addressing scheme. Any data storage device capable of both being connected to a fibre channel switch (120) and managing bandwidth between multiple requesting applications on one or more client devices (110) may be used in addition to, or in place of, the disk array (130).

The fibre channel switch (120) is also connected to a management station (150) via a communication line (118a) that leads to an HBA (140) of the management station (150). As will be described herein, the management station (150) monitors the use of the data storage resources (e.g., array 130) by the applications running on the population of client devices (110) and makes bandwidth allocations accordingly. The management station (150) controls operation of the fibre channel switch (120) via the communication line (118a).

Beginning again at the client devices (110), an additional set of communication lines (116) connect output from the response time data reporter (RTDR) (112) contained within each client device (110) to a transmission control protocol/Internet protocol (TCP/IP) switch (170). A TCP/IP switch (170) is a switch that allows for the simultaneous transmission of data from the multiple response time data reporters (112) located on the client devices (110) to the management station (150).

Continuing from the TCP/IP switch is a communication line (117). The communication line (117) leads from the TCP/IP switch (170) to a network interface card (NIC) (160) that is integrally connected to the management station (150). A NIC (160) is typically a computer circuit board or card that is installed in a computing device, such as the management station (150), so that the computing device can be connected to a network. The NIC (160) provides a dedicated, full-time connection between the management station (150) and the network, including the client devices (110). While a NIC is typically built on a board or card, this is not necessarily so.

The management station (150) is communicatively coupled to both the fibre channel switch (120) and the TCP/IP switch (170), preferably in the manner explained above. The management station (150) is a unit capable of both monitoring the response rate of the disk array (130) to data requests made by applications on the client devices (110) and adjusting the bandwidth allocation levels for each of the applications on the client devices (110) through the fibre channel switch (120).

The management station (150) is a computing device that provides the functionality described herein. The management station (150) may be a programmed general-purpose computer or may be specifically designed and constructed to provide the functionality here described.

In one embodiment, the management station (150) is a computer that runs various applications that are stored in the memory of the station (150). These applications include, a response time data collector (158), a response time manager (156), a bandwidth decision algorithm (154) and an application policy manager control (152). These applications may be separate programs or tasks that run on the management station (150) under an operating system. Alternatively, these applications may be tasks or subroutines that are integrated into a single piece of software of firmware on the management station (150). In another alternative, these applications may be functions that are implemented with one or more application specific integrated circuits (ASICs) or other logical components within the management station (150). Thus, the described functionality of the management station (150) can be provided in a number of ways.

The response time data collector (158) receives data from the NIC (160). Through the NIC (160), the response time data collector (158) receives response time data from the response time data reporters (112) of the client devices (110). This response time data indicates how quickly the data storage resources of the network (e.g., the disk array (130)) respond to requests from each particular application running on the client devices (110).

The response time data collector (158) of the management station (150) provides the response time data collected to the response time manager (156). The response time manager (156) calls or includes the bandwidth decision algorithm (154). The bandwidth decision algorithm (154) will use the response time data to make decisions about the optimal bandwidth allocations among the applications on the client devices (110).

The response time manager (156) provides output to the application policy manager control (152) based on the output of the bandwidth decision algorithm (154). The application policy manager control (152) accesses the HBA (140) of the management station (150) to communicate with the fibre channel switch (120) and adjust the bandwidth allocation levels of the various applications running on the client devices (110).

Exemplary Implementation and Operation

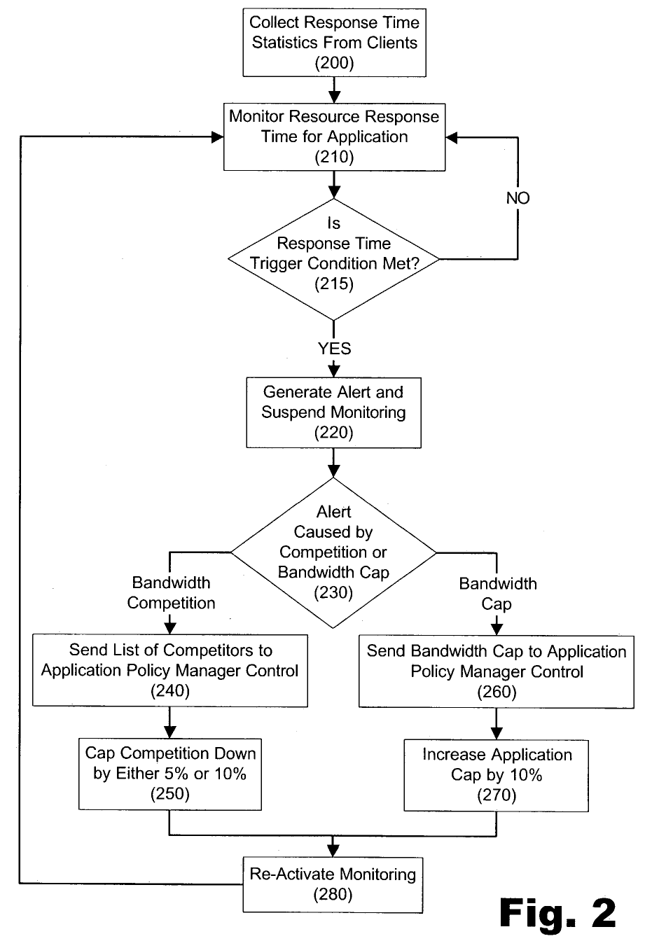

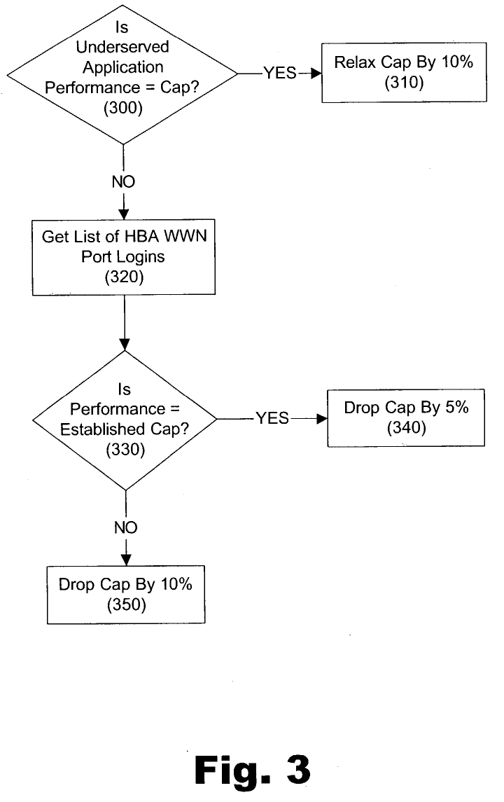

FIGS. 2 and 3 illustrate the implementation and operation of, for example, the structure illustrated in FIG. 1. With reference to both FIGS. 1 and 2, operations begin by collecting response time statistics from the client devices (110). (Step 200, FIG. 2). The collection is performed by the response time data reporter (112) located in each client device (110). As indicated above, each response time data reporter (112) will generate information about the response time performance of the data storage resources to the application or applications running on a respective client device. The response time data reporter (112) notes when data read/write requests are sent from an application running on a client device (110) and the time elapsed before the request is met by the network's data storage resources, for example, the disk array (130).

Once the response time data reporter (112) collects the response time data, the response time data is sent from the response time data reporter (112) of each client device (110) through the communication line (116), to the TCP/IP switch (170). The TCP/IP switch (170) sends the response time data through the NIC (160) of the management station (150) to the response time data collector (158) for analysis.

When the management station (150) receives the response time statistics from the response time data reporter (112) of each client device (110), the response time manager (156) of the management station (150) monitors the response time of the data storage resources assigned to each application running on the client devices (110) for trigger conditions. (Step 210, FIG. 2).

Trigger conditions are, for example, performance values that specify the minimum allowable performance that the data storage resources of the network should provide to respective applications. Typically, the trigger conditions are specified by a user or system operator.

The response time manager (156) of the management station (150) functions as a monitoring daemon. A daemon is a program that runs continuously during system operation and exists for the purpose of handling periodic service requests that a computing device expects to receive. As applied to the storage area network, the response time manager (156) continuously monitors the response time data received in the response time data collector (158) for the existence of the trigger conditions (step 210).

The response time data received in the response time manager (156) may indicate that one of the user established trigger conditions has been met (determination 215, FIG. 2), e.g., an application on one of the client devices is receiving less than a specified minimum of service from the data storage resources of the network. When the trigger conditions occur, the response time manager (156) generates an alert (155) and, preferably, temporarily suspends further monitoring of response times. (Step 220, FIG. 2). The application that experiences the trigger conditions and causes the alert to be generated may be referred to as the “underserved application.”

When a trigger condition is met and the subsequent alert (155) has been generated, the management station (150) determines the cause of the trigger condition. The response time of a data storage resource to applications running on the client devices (110) is typically increased when the bandwidth allocated to an application is either competing for bandwidth with other applications or is limited by a system established bandwidth allocation restriction or cap. When determining the cause of the alert (155), the management station (150) determines whether the trigger condition was met due to bandwidth competition between applications or whether the trigger condition was met because the bandwidth being used by the underserved application reached an established bandwidth restriction or cap. (Determination 230, FIG. 2). As described above, the management station (150) uses a bandwidth decision algorithm (154) to determine and remedy the cause of the alert (155).

FIG. 3 further illustrates the analysis performed by the bandwidth decision algorithm (154; FIG. 1). Once the bandwidth decision algorithm (154; FIG. 1) is executed, the algorithm determines whether the amount of bandwidth being used by the underserved application (hereinafter referred to as the ‘performance level’) is equal to the current bandwidth cap level of that application. (Determination 300). If the performance level of the underserved application is substantially equal to the cap level for the underserved application, the underserved application is likely operating at its maximum allowable performance level and is being restricted by bumping against its own established bandwidth cap.

In order to remedy the cap limitation, the bandwidth decision algorithm (154; FIG. 1) will determine to relax the underserved application's bandwidth allocation cap, for example, by 10%. (Step 310). If, however, the underserved application performance level is not equal to the underserved application bandwidth cap, its own cap is not restricting the underserved application. Thus, it is most likely the case that there is bandwidth competition occurring between applications, perhaps on multiple client devices.

If the bandwidth decision algorithm (154; FIG. 1) determines that the alert condition is caused by bandwidth competition occurring between applications, the bandwidth decision algorithm (154; FIG. 1) obtains a list of HBA WWN port logins. (Step 320). The list of HBA WWN port logins is retrieved in order to identify which ports are currently competing with the underserved application for bandwidth allocation. Once the competing client device ports are identified and performance level information for the competing devices is collected from the response time manager (156; FIG. 1), the bandwidth decision algorithm (154; FIG. 1) determines the bandwidth reallocation to be performed to remedy the alert causing conditions.

First, the bandwidth decision algorithm determines whether the performance level of each of the listed competing HBAs is equal to the corresponding bandwidth cap level for that HBA. (Determination 330). If the competing HBAs are functioning at their established bandwidth cap levels, the bandwidth cap levels on the competing HBAs are tightened, for example, by 5% (step 340). The tightening of the cap levels of the competing HBAs that are functioning at their respective bandwidth cap levels reduces the bandwidth allowed for each competing client device thereby allowing more overall bandwidth to be available for client device with the underserved application. If, however, the performance level of the competing HBAs is not equal to their established cap level, the cap levels corresponding to those competing HBAs are overly loose. In order to remedy the looseness of the competing HBA cap levels, the bandwidth decision algorithm determines that the cap levels should be dropped even further, for example, by 10%. (Step 350). The exemplary 10% drop in competing HBA cap levels is performed in order to free additional bandwidth for the client device with the underserved application. The current embodiment is illustrated using bandwidth allocation cap adjustments of 5% and 10%; however, any percentage bandwidth allocation adjustment may be employed based on the operational needs and characteristics of the system.

Referring again to FIGS. 1 and 2, once the bandwidth decision algorithm (154) has determined both the cause of the alert (155) and the action desired to remedy the situation, the desired action is performed. If the bandwidth decision algorithm (154) determines that the underserved application is bumping against its own established bandwidth cap, the current underserved application cap level is sent to the application policy manager control (152) along with commands to relax the underserved application's bandwidth allocation cap by, for example, 10%. (Step 260; FIG. 2) Once the application policy manager control (152) receives the command to relax the bandwidth allocation cap for the underserved application, the application policy manager control (152) relaxes the bandwidth allocation cap for the underserved application by, for example, 10%. (Step 270, FIG. 2). The relaxation of the cap enables the client device executing the underserved application to utilize an additional portion of available bandwidth.

If the bandwidth decision algorithm (154) has determined that the alert causing condition is a result of competition between applications on different client devices (110), the bandwidth decision algorithm (154) also determines whether the competing applications are operating at levels equal to their respective bandwidth caps. If the competing applications are operating at levels equal to their respective bandwidth caps, the application policy manager control (152) receives the instruction to tighten the bandwidth allocation caps of the competing applications by, for example, 5%. (Steps 240 & 250, FIG. 2). By tightening the allocation caps of the competing applications, the management station (150) allows more bandwidth to be available for the underserved application. If, however, some of the competing applications are not operating at their respective bandwidth caps, the application policy manager control may be instructed to tighten bandwidth caps for those applications even more, for example, by 10%. (Step 250). When the application policy manager control (152) has received instructions from the bandwidth decision algorithm (154), the application policy manager control (152) implements those instructions by appropriately controlling the FC-switch (120) that provides client access to the network resources, such as, the disk array (130). When the necessary caps have been adjusted to allow for more use of available bandwidth by the underserved application, the management station (150) re-activates its previous monitoring of the response time associated with each application. (Step 280, FIG. 2) The response time monitoring is re-activated in order to assure that the action taken to remedy the alert causing condition was successful and to continue monitoring for additional trigger conditions. The process described above may be performed in a repetitive manner to optimize bandwidth allocation levels in a storage area network.

In conclusion, the various embodiments described allow for a dynamic allocation of bandwidth among applications on a network based on real-time measurements of the bandwidth needs and usage of those applications. Consequently, the embodiments described reduce or eliminate wasted bandwidth caused by the use of predictive analysis and theoretical maximums.

The preceding description has been presented only to illustrate and describe the invention. It is not intended to be exhaustive or to limit the invention to any precise form disclosed. Many modifications and variations are possible in light of the above teaching. It is intended that the scope of the invention be defined by the following claims.

What is claimed is:

1. A system for managing bandwidth allocation in a storage area network comprising:
a management station configured to control bandwidth between one or more data storage devices and a plurality of applications that run on one or more client devices, wherein said management station monitors response times in which said data storage device responds to requests from said applications and adjusts bandwidth allocations for said applications based on said response times.

2. The system of claim 1, further comprising a plurality of client devices networked to said data storage device through a fibre channel switch.

3. The system of claim 2, further comprising a connection between said management station and said fibre channel switch, wherein said management station controls said bandwidth allocations for said applications by controlling said fibre channel switch.

4. The system of claim 1, where in said data storage device comprises at least one disk array.

5. The system of claim 1, further comprising a plurality of client device each of which comprise a response time data reporter, wherein said response time data reporter reports said response times to said management station.

6. The system of claim 5, wherein said response time data reporter comprises a task that is stored on and executed by a said client device.

7. The system of claim 5, further comprising a switch connected between said monitoring station and each of said client devices, said switch allowing said response time data reporters to report to said management station.

8. The system of claim 7, wherein said switch comprises a TCP/IP switch.

9. The system of claim 7, wherein said management station comprises a response time data collector that receives response time reports from said response time reporters.

10. The system of claim 9, wherein said response time data collector is an application stored on and executed by said management station.

11. The system of claim 9, wherein said management station further comprises a response time manager and a bandwidth decision algorithm that receive response time data from said response time data collector and make decisions about changes in bandwidth allocation based on said response time data.

12. The system of claim 11, wherein said response time manager and bandwidth decision algorithm are an application stored on and executed by said management station.

13. The system of claim 11, wherein said management station further comprises an application policy manager control for receiving said decisions from said response time manager and bandwidth decision algorithm and for implementing bandwidth allocations based on said decisions.

14. The system of claim 13, wherein said application policy manager control is an application stored on and executed by said management station.

15. A storage area network having dynamic bandwidth allocations comprising:
a data storage device;
a plurality of client devices networked to said data storage device, wherein each client device runs one or more applications which access said data storage device through connections of said storage area network; and
a management station connected to said storage area network and configured to control bandwidth between said data storage devices and said applications on said client devices,
wherein said management station monitors response times in which said data storage device responds to requests from said applications and adjusts bandwidth allocations for said applications based on said response times.

16. The network of claim 15, further comprising a fibre channel network connecting said client devices to said data storage device, wherein all connections between said client devices and said data storage device pass through a fibre channel switch controlled by said management station.

17. The network of claim 15, where in said data storage device comprises at least one disk array.

18. The network of claim 15, wherein each client device comprises a response time data reporter, said response time data reporter reporting said response times to said management station.

19. The network of claim 18, wherein said response time data reporter comprises a task that is stored on and executed by a respective client device.

20. The network of claim 18, further comprising a switch connected between said monitoring station and each of said client devices, said switch allowing said response time data reporters to report to said management station.

21. The network of claim 20, wherein said switch comprises a TCP/IP switch.

22. A method for managing bandwidth allocation in a storage area network comprising:
monitoring a response time of data storage resources to requests from applications on at least two client devices to produce response time data;
determining whether a trigger condition is met based on said response time data; and
if said trigger condition is met, adjusting bandwidth allocation levels of said applications.

23. The method of claim 22, wherein said monitoring said response time comprises collecting response time data with a response time data reporter at each client device.

24. The method of claim 23, further comprising sending said response time data from each response time data reporter to a management station which performs said monitoring.

25. The method of claim 24, further comprising executing firmware on said management station which receives said response time data and performs said monitoring.

26. The method of claim 22, wherein said trigger condition comprises a minimum acceptable response time performance level for a designated application that runs on a client device.

27. The method of claim 26, further comprising allowing a user to establish said trigger condition.

28. The method of claim 22, wherein said adjusting bandwidth allocation levels of said applications comprises:
determining whether said trigger condition is caused by one of said applications reaching a bandwidth cap or by input/output (I/O) competition between said applications;
if said trigger condition was caused by an application reaching a bandwidth cap, increasing said bandwidth cap; and
if said trigger condition was caused by competition, reducing bandwidth allocation levels for applications that are competing with an underserved application.

29. The method of claim 28, wherein increasing said bandwidth cap comprises increasing said bandwidth cap by ten percent.

30. The method of claim 28, wherein reducing said bandwidth allocation levels comprises reducing bandwidth allocation levels by five to ten percent.

31. The method of claim 28, wherein reducing said bandwidth allocation levels comprises:
determining whether said competing applications are substantially operating at respective bandwidth allocation levels;
if said competing applications are operating at respective bandwidth allocation levels, reducing said bandwidth allocation levels by five percent; and
if said competing applications are not operating at respective bandwidth allocation levels, reducing said bandwidth allocation levels by ten percent.

32. The method of claim 22, further comprising:
suspending said monitoring when said trigger condition is met; and
resuming said monitoring after said adjusting of said bandwidth allocation levels has been performed.

33. A device for managing bandwidth allocation in a storage area network comprising:
means for monitoring a response time of data storage resources to requests from applications on at least two client devices to produce response time data;
means for determining whether a trigger condition is met based on said response time data; and
if said trigger condition is met, means for adjusting bandwidth allocation levels of said applications.

34. The device of claim 33, wherein said means for monitoring said response time comprises means for collecting response time data with a response time data reporter at each client device.

35. The device of claim 34, further comprising means for sending said response time data from each response time data reporter to a management station which comprises said means for monitoring.

36. The device of claim 33, wherein said trigger condition comprises a minimum acceptable response time performance level for a designated application that runs on a client device.

37. The device of claim 36, further comprising input means for allowing a user to set said trigger condition.

38. The device of claim 33, wherein said means for adjusting bandwidth allocation levels of said applications comprises:
means for determining whether said trigger condition is caused by one of said applications reaching a bandwidth cap or by input/output (I/O) competition between said applications;
means for increasing a bandwidth cap if said trigger condition was caused by an application reaching said bandwidth cap; and
means for reducing bandwidth allocation levels for applications that are competing with an underserved application, if said trigger condition was caused by the competition.

39. The device of claim 38, wherein said means for reducing said bandwidth allocation levels comprises:
means for determining whether said competing applications are substantially operating at respective bandwidth allocation levels;
means for reducing said bandwidth allocation levels by five percent, if said competing applications are operating at respective bandwidth allocation levels; and
means for reducing said bandwidth allocation levels by ten percent, if said competing applications are not operating at respective bandwidth allocation levels.

40. The device of claim 33, further comprising:
means for suspending said monitoring when said trigger condition is met; and
means for resuming said monitoring after adjusting said bandwidth allocation levels.

41. Computer-readable instructions stored on a computer-readable medium for causing a monitoring station to dynamically manage bandwidth allocation in a storage area network, wherein said instructions, when executed, cause said monitoring station to:
receiving response time data indicating how quickly data storage resources of said storage area network respond to requests from applications on at least two client devices;
determine whether a trigger condition is met based on said response time data; and
if said trigger condition is met, adjust bandwidth allocation levels of said applications.

42. The instructions of claim 41, wherein said trigger condition comprises a minimum acceptable response time performance level for a designated application that runs on a client device.

43. The instructions of claim 42, wherein said instructions further cause said monitoring station to receive user input establishing said trigger condition.

44. The instructions of claim 41, wherein said instructions cause said management station to adjust bandwidth allocation levels of said applications by:
determining whether said trigger condition is caused by one of said applications reaching a bandwidth cap or by input/output (I/O) competition between said applications;
if said trigger condition was caused by an application reaching a bandwidth cap, increasing said bandwidth cap; and
if said trigger condition was caused by competition, reducing bandwidth allocation levels for applications that are competing with an underserved application.

45. The instructions of claim 44, wherein, if said trigger condition was caused by competition, said instructions cause said management station to reduce bandwidth allocation levels of said applications by:
determining whether said competing applications are substantially operating at respective bandwidth allocation levels;
if said competing applications are operating at respective bandwidth allocation levels, reducing said bandwidth allocation levels by five percent; and
if said competing applications are not operating at respective bandwidth allocation levels, reducing said bandwidth allocation levels by ten percent.

46. The instructions of claim 41, wherein said instructions cause said management station to:
suspend monitoring when said trigger condition is met; and
resume monitoring after said bandwidth allocation levels have been adjusted.
